(19) United States
(12) Patent Application Publication
(10) Pub. No.: US 2013/0330089 A1
(43) Pub. Date: Dec. 12, 2013

(54) BACKGROUND NOISE-IMMUNE LED-BASED COMMUNICATION DEVICE

(71) Applicants: Chi-Wai Chow, Hong Kong (HK); Chien-Hung Yeh, New Taipei City (TW); Yu-Feng Liu, New Taipei City (TW); Po-Yen Huang, Taipei City (TW)

(72) Inventors: Chi-Wai Chow, Hong Kong (HK); Chien-Hung Yeh, New Taipei City (TW); Yu-Feng Liu, New Taipei City (TW); Po-Yen Huang, Taipei City (TW)

(21) Appl. No.: 13/603,066

(22) Filed: Sep. 4, 2012

(30) Foreign Application Priority Data
Jun. 8, 2012 (TW) 101120702

(51) Int. Cl. H04B 10/02

(52) U.S. Cl. 398/135

(57) ABSTRACT

A background noise-immune LED-based communication device comprises at least one LED signal transmitter emitting a Manchester code signal generated by a Manchester coding technology; and at least one optical receiver receiving the Manchester code signal from the LED signal transmitter. The present invention applies the Manchester coding technology to visible-light communication devices, enabling the LED-based communication device to transmit the Manchester code signal, whereby is decreased noise and promoted signal quality.

### BACKGROUND OF THE INVENTION

1. Field of the Invention

The present invention relates to a visible-light communication device, particularly to a background noise-immune LED-based communication device, which transmits signals in form of the Manchester code.

2. Description of the Related Art

Conventional LED (Light Emitting Diode)-based communication devices are likely to be interfered with by background noise. If the background noise can be eliminated from the signals, a better communication quality should be attained. Therefore, filters are usually installed in conventional LED-based communication devices to eliminate background noise. However, the filtering activity may also degrade the quality of signals. Besides, filters would increase the cost and complexity of communication devices.

An existing approach to eliminate noise for an LED-based communication device is to arrange an optical filter before the optical receiver to retrieve the desired frequency band, whereby the communication device is exempted from noise interference and signal quality degradation. The abovementioned measure can not eliminate interference coming from the same frequency band but only eliminates interference coming from different frequency bands. Besides, an optical filter is unlikely to eliminate noise of the visible light spectrum. The Manchester code, which is adopted by the present invention, is a simple and inexpensive method to eliminate noise interference coming from the same frequency band.

In a paper “Performance Improvement in Visible Light Communication by Using Spread Spectrum Coding”, the LED-based communication device adopts a CDMA (Code Division Multiple Access) technology, which only retrieves specified orthogonal sequence signals, wherefore it can effectively overcome the of background noise of wideband. As the CDMA technology can adopt different orthogonal bases, it can transmit different signals to different users simultaneously. The CDMA technology can indeed decrease the low-frequency noise of wideband. However, the CDMA technology uses different orthogonal sequences to discriminate different users and thus consumes considerable bandwidth. For example, there is background noise at a frequency of 90 kHz or in the range of 0-90 kHz. The orthogonal sequences outside the frequency range of the background noise can work normally. However, the orthogonal sequences corresponding to the frequency range cannot work because of the background noise interference. Thus, some users cannot receive signals from others. Contrarily, the Manchester coding technology not only can decrease interference of the background light noise but also can more effectively utilize bandwidth.

Accordingly, the present invention proposes a background noise-immune LED-based communication device to solve the abovementioned problems.

### SUMMARY OF THE INVENTION

The primary objective of the present invention is to provide a background noise-immune LED-based communication device, which adopts a Manchester coding technology to promote signal quality and reduce signal noise.

Another objective of the present invention is to provide a background noise-immune LED-based communication device, which has simple structure, and which can decrease noise, lower the device cost and reduce the device complexity without using any additional filter.

To achieve the abovementioned objectives, the present invention proposes a background noise-immune LED-based communication device, which comprises at least one LED signal transmitter emitting a Manchester code signal; and at least one optical receiver receiving the Manchester code signal, wherein the Manchester code signal is coded by the Manchester coding technology.

Below, embodiments are described in detail to make easily understood the objectives, technical contents, characteristics and accomplishments of the present invention.

### BRIEF DESCRIPTION OF THE DRAWINGS

FIG. 1 schematically shows the architecture of a background noise-immune LED-based communication device according to a first embodiment of the present invention;

FIG. 2 schematically shows the architecture of a background noise-immune LED-based communication device according to a second embodiment of the present invention;

FIG. 3 schematically shows the architecture of a background noise-immune LED-based communication device used in an experiment according to a third embodiment of the present invention;

FIG. 4 shows the Q values of LED-based communication devices respectively using the Manchester coding technology and the NRZ coding technology at a transmission rate of 1.25 Mbps;

FIG. 5a shows the eye pattern of a LED-based communication device using the Manchester coding technology at a transmission rate of 1.25 Mbps;

FIG. 5b shows the eye pattern of a LED-based communication device using the NRZ coding technology at a transmission rate of 1.25 Mbps;

FIG. 6 shows the Q values of LED-based communication devices respectively using the Manchester coding technology and the NRZ coding technology at a transmission rate of 2.5 Mbps;

FIG. 7a shows the eye pattern of a LED-based communication device using the Manchester coding technology at a transmission rate of 2.5 Mbps;

FIG. 7b shows the eye pattern of a LED-based communication device using the NRZ coding technology at a transmission rate of 2.5 Mbps.

### DETAILED DESCRIPTION OF THE INVENTION

The present invention discloses a background noise-immune LED-based communication device, which comprises at least one LED signal transmitter and at least one optical receiver that are respectively installed in different electronic devices or jointly installed in an identical electronic device.

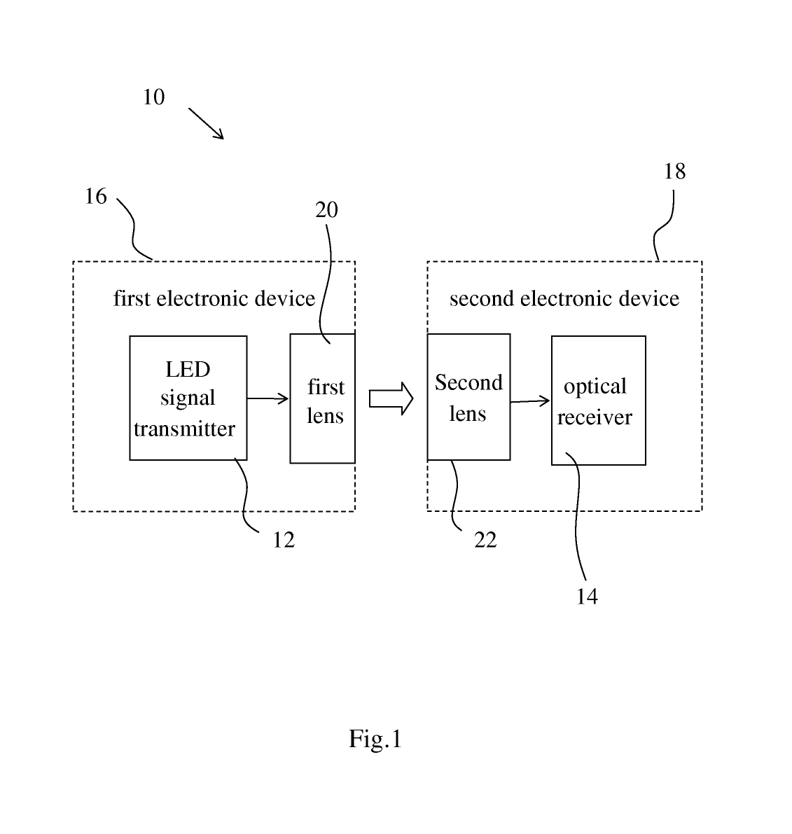

Firstly is described a first embodiment wherein the LED signal transmitter and the optical receiver are respectively installed in different electronic devices. Refer to FIG. 1. A LED signal transmitter 12 and an optical receiver 14 of a LED-based communication device 10 are respectively installed in a first electronic device 16 and a second electronic device 18. The first electronic device 16 uses the LED signal transmitter 12 to transmit a Manchester code signal to the second electronic device 18. In this embodiment, the LED signal transmitter 12 is a white light LED. The first electronic device 16 includes a first lens 20. The LED signal transmitter 12 emits a Manchester code signal. The Manchester code signal passes through the first lens 20 and then reaches the optical receiver 14 installed in the second electronic device 18. The optical receiver 14 includes a second lens 22. The Manchester signal is received by the optical receiver 14 through the second lens 22. The second electronic device 18 analyzes the received Manchester code signal. The LED signal transmitter 12 can sequentially generate and transmit different Manchester code signals to different optical receivers 14.

The abovementioned Manchester code signal is coded by a Manchester coding technology. The Manchester coding technology is normally used in the coding activities of LAN (Local Area Network). However, the present invention applies the Manchester coding technology to LED-based communication devices to eliminate low-frequency noise and upgrade signal quality.

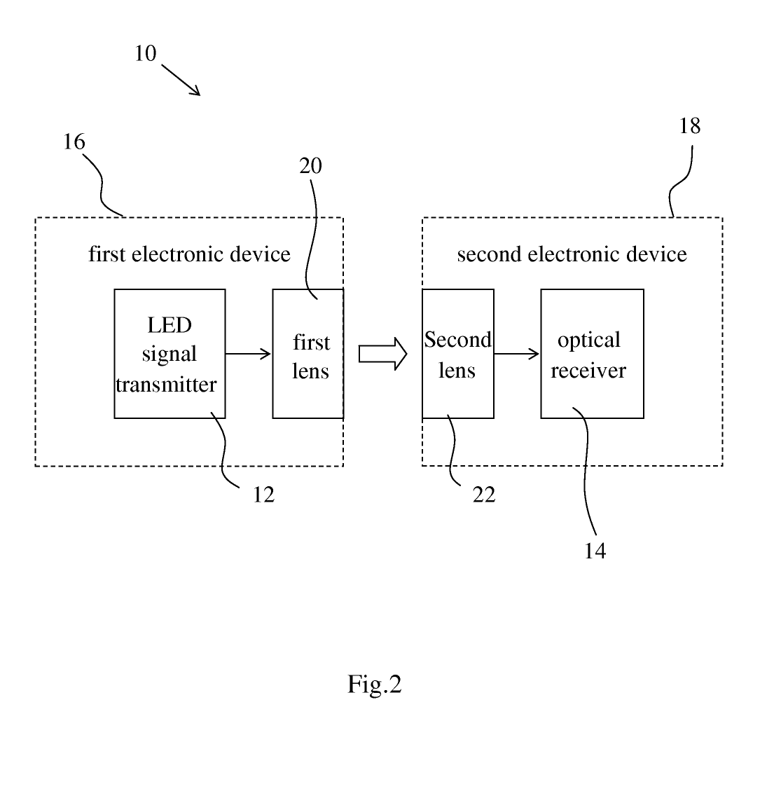

Refer to FIG. 2. In a second embodiment, the first electronic device 16 simultaneously has the LED signal transmitter 12 and an optical receiver 30, wherein the LED signal transmitter 12 and the optical receiver 30 respectively include the first lens 20 and a second lens 32. In this embodiment, the second electronic device 18 simultaneously has a LED signal transmitter 36 functioning similarly to that of the first electronic device 16 and the optical receiver 14, wherein the LED signal transmitter 36 and the optical receiver 14 respectively include a first lens 34 and the second lens 22. Thereby, the LED signal transmitter 12 installed in the first electronic device 16 transmits a Manchester code signal through the first lens 20 to the optical receiver 14 installed in the second electronic device 18. The optical receiver 14 receives the Manchester code signal through the second lens 22. Then, the second electronic device 18 processes and analyzes the Manchester code signal. Further, the LED signal transmitter 36 installed in the second electronic device 18 transmits a Manchester code signal through the first lens 34 to the optical receiver 30 installed in the first electronic device 16. The optical receiver 30 receives the Manchester code signal through the second lens 32. Then, the first electronic device 16 processes and analyzes the Manchester code signal. Therefore, either of the first electronic device 16 and the second electronic device 18 transmits the Manchester code signal to the opposite side, receives the Manchester code signal from the opposite side, processes and analyzes the Manchester code signal coming from the opposite side.

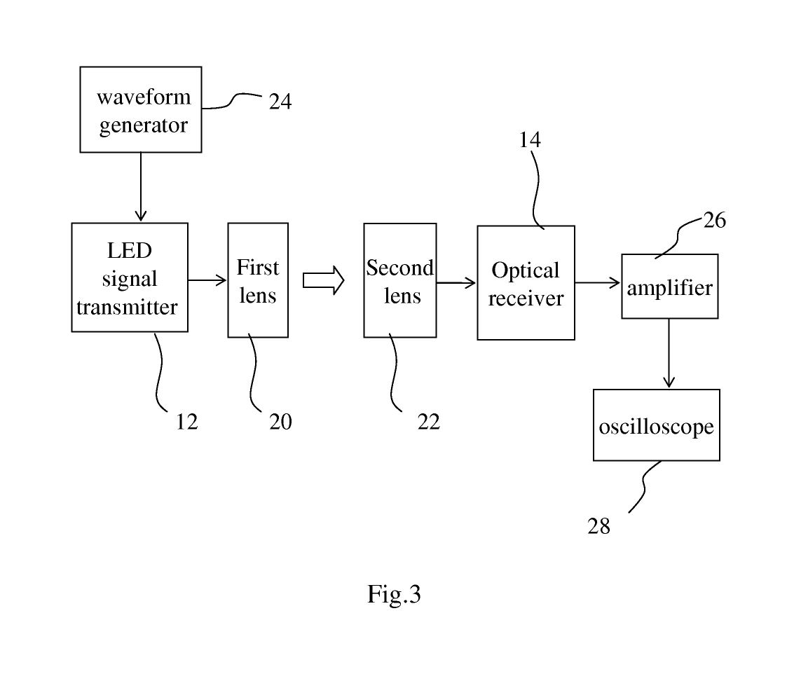

Below are described the results of the experiment that compares the performances of the same LED-based communication devices respectively using different coding methods. FIG. 3 shows the architecture of the LED-based communication device used in the experiment according to a third embodiment of the present invention. A waveform generator 24 generates a waveform. The LED signal transmitter 12 sends out an electromagnetic signal having the waveform through the first lens 20. The optical receiver 14 receives the electromagnetic signal through the second lens 22. An amplifier 26 amplifies the received electromagnetic signal. The amplified signal is transmitted to and presented on an oscilloscope 28. This experiment uses fluorescent lamp light as the background noise to observe the performances of different coding methods under the same noise environment.

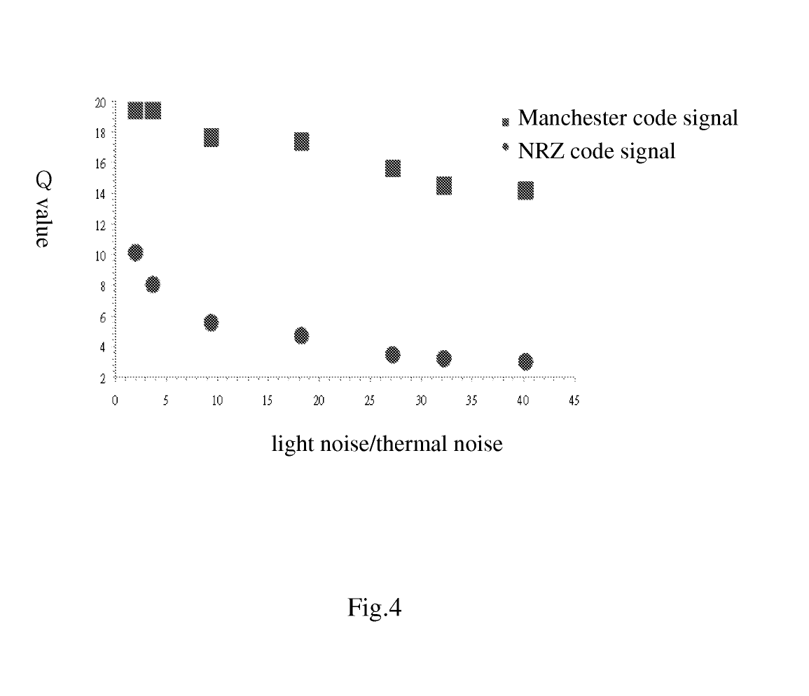

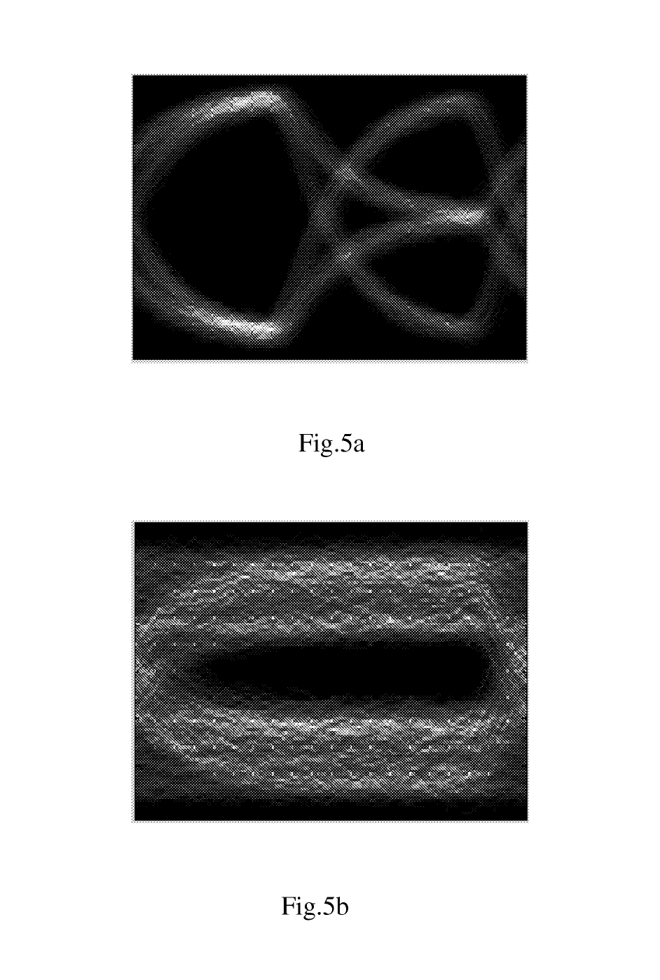

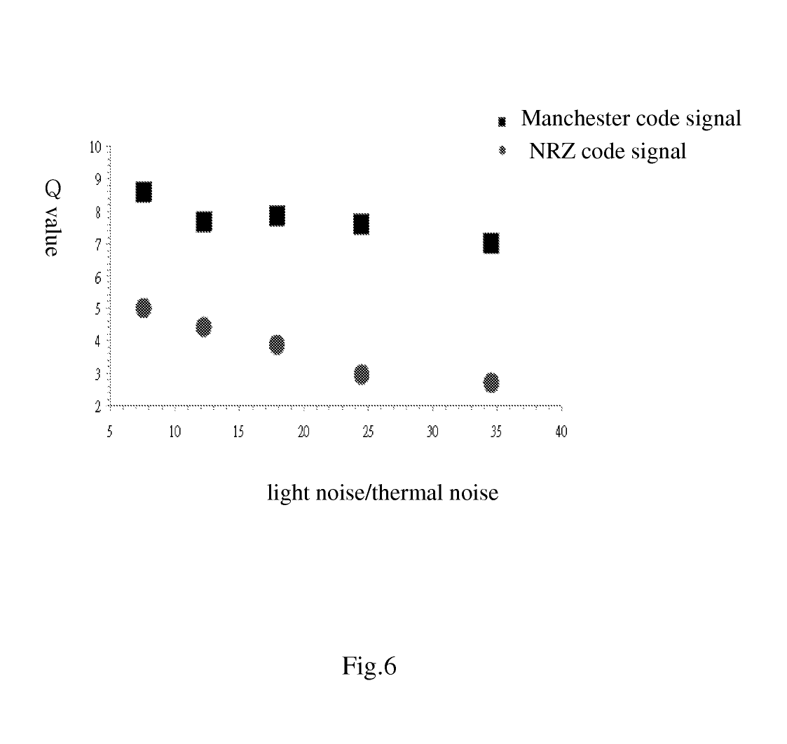

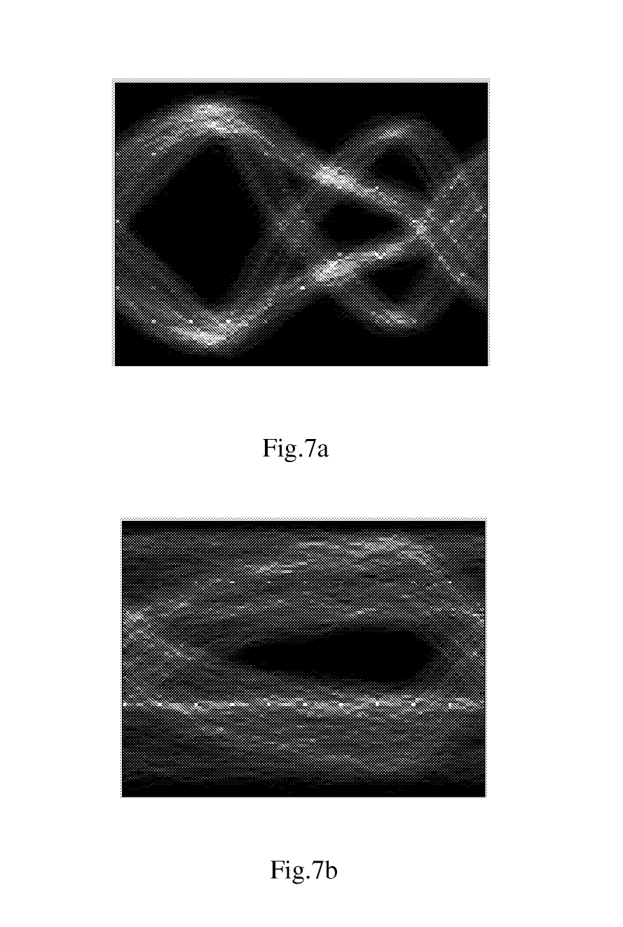

This experiment compares the NRZ (Non-Return to Zero) coding method and the Manchester coding method under the environment of light noise and thermal noise generated by a fluorescent lamp. Under different ratios of light noise and thermal noise is measured a Q value defined as

$$Q = \frac{{μ}_{1} - {μ}_{0}}{{σ}_{1} + {σ}_{0}}$$

wherein μ₀ and μ₁ are respectively the averages of the received “0” and “1” signals, and wherein σ₀ and σ₁ are respectively the standard deviations of the received “0” and “1” signals. Refer to FIG. 4. In the case that the transmission rate of the LED signal transmitter is 1.25 Mbps and the ratio of light noise and thermal noise is 32, the Q value of the Manchester code signal measures greater than 14, but the Q value of the NRZ code signal measures only about 3. Refer to FIG. 5a and FIG. 5b, which show that the eye pattern of the Manchester code signal is far clearer than the eye pattern of the NRZ code signal. Refer to FIG. 6. In the case that the transmission rate of the LED signal transmitter is 2.5 Mbps and the ratio of light noise and thermal noise is 35, the Q value of the Manchester code signal measures about 7, at which the transmitted information is still correct. However, the Q value of the NRZ code signal measures only about 2.5 in the case. Refer to FIG. 7a and FIG. 7b, which show that the eye pattern of the Manchester code signal is still much clearer than the eye pattern of the NRZ code signal. It should be particularly mentioned that the bandwidth occupied by the Manchester code signal is double the bandwidth occupied by the NRZ code signal at the same transmission rate. Therefore, the eye-duration of the Manchester code signal is only half the eye-duration of the NRZ code signal.

From the experimental results, it is learned that the Manchester coding technology can completely eliminate noise while the frequency of the background noise is far smaller than the transmission rate of the LED signal transmitter. The signal received from the conventional LED signal transmitter is likely to be interfered with by the low-frequency noise generated by a fluorescent lamp. However, the LED signal transmitter adopting the Manchester coding technology is immune from the background noise generated by a fluorescent lamp.

In conclusion, the present invention applies the Manchester coding technology to visible-light communication devices. The present invention enables the LED-based communication device to transmit the Manchester code signal, decreasing noise and promoting signal quality. Further, the present invention can decrease noise without increasing hardware complexity because the present invention needn't use any additional apparatus to decrease noise.

The embodiments described above are only to exemplify the present invention but not to limit the scope of the present invention. Any equivalent modification or variation according to the characteristic or spirit of the present invention is to be also included within the scope of the present invention.

What is claimed is:

1. A background noise-immune LED-based communication device comprising:
at least one LED (Light Emitting Diode) signal transmitter emitting a Manchester code signal generated by a Manchester coding technology; and
at least one optical receiver receiving said Manchester code signal from said LED signal transmitter.

2. The background noise-immune LED-based communication device according to claim 1, wherein said LED signal transmitter is arranged in a first electronic device, and said optical receiver is arranged in a second electronic device, and wherein said first electronic device uses said LED signal transmitter to transmit said Manchester cod signal to said second electronic device, and wherein said second electronic device processes and analyzes said Manchester code signal.

3. The background noise-immune LED-based communication device according to claim 1, wherein each of a first electronic device and a second electronic device has both of said LED signal transmitter and said optical receiver, and wherein said first electronic device and said second electronic device transmit said Manchester code signal to each other and receive said Manchester code signal from each other.

4. The background noise-immune LED-based communication device according to claim 1 further comprising a first lens arranged in said LED signal transmitter, wherein said LED signal transmitter transmits said Manchester code signal through said first lens.

5. The background noise-immune LED-based communication device according to claim 1 further comprising a second lens arranged in said optical receiver, wherein said optical receiver receives said Manchester code signal through said second lens.

6. The background noise-immune LED-based communication device according to claim 1, wherein said LED signal transmitter is a white-light LED.

7. The background noise-immune LED-based communication device according to claim 1, wherein said LED signal transmitter transmits different Manchester code signals to different optical receivers.

8. The background noise-immune LED-based communication device according to claim 1, wherein said LED signal transmitter sequentially transmits different said Manchester code signals to different said optical receivers.
